(19) United States
(12) Patent Application Publication
(10) Pub. No.: US 2014/0291424 A1
(43) Pub. Date: Oct. 2, 2014

(54) Spray Nozzle and Coating System Using the Same

(71) Applicant: Enjet Co. Ltd., Gyeonggi-do (KR)

(72) Inventors: Do-Young Byun, Seoul (KR); Vu Dat Nguyen, Gyeonggi-do (KR); Baek Hoon Seong, Gyeongsangbuk-do (KR)

(73) Assignee: Enjet Co. Ltd., Gyeonggi-do (KR)

(21) Appl. No.: 14/226,916

(22) Filed: Mar. 27, 2014

(30) Foreign Application Priority Data
Mar. 28, 2013 (KR) 10-2013-0033536

(51) Int. Cl. B05B 5/03; B05B 5/08

(52) U.S. Cl. CPC B05B 5/03; B05B 5/08
USPC 239/695; 239/707

(57) ABSTRACT

Provided herein is a spray nozzle and a coating system using the same, the spray nozzle and the coating system comprising a liquid nozzle injecting liquid towards a substrate; a gas nozzle for injecting gas to collide with the liquid on an injection path of the liquid to perform a primary atomization of the liquid; and a voltage supply connected to the liquid nozzle, the voltage supply for applying voltage to the liquid nozzle to generate an electric field between the liquid nozzle and substrate to perform a secondary atomization of the liquid.

### CROSS-REFERENCE TO RELATED APPLICATIONS

This application claims the benefit of priority under 35 U.S.C. §119(a) of Korean Patent Applications No. 10-2013-0033536, filed on Mar. 28, 2013, in the Korean Intellectual Property Office, the entire disclosure of which is incorporated herein by reference for all purposes.

### BACKGROUND

1. Field

The following description relates to a spray nozzle and a coating system using the same, and more particularly, to a spray nozzle that is capable of atomizing an injection liquid and stably injecting fine droplets of a uniform size, and increasing the amount of injection so that it can be applied to mass production processes, and a coating system thereof.

2. Description of Related Art

A coating process is essential in not only traditional industrial areas such as automobile and construction, but also in manufacturing areas such as display and solar cell etc. Especially, when manufacturing displays such as organic solar cells and organic light emitting diodes (OLED) etc., there is required a precise coating of a thickness of tens to hundreds nanometers. In addition, since the roughness and uniformity of a coating surface have a significant effect on the performance of a product, it should be possible to use ultrafine droplets, and to coat the product quickly for mass production.

Recently, as application of touch screens increases, anti-fingerprint coating or anti-reflecting coating method for application on the surfaces of touch window surfaces such as smart phones, tablets, notebook computers etc. are being converted into wet coating processes instead of conventional vacuum coating processes.

The technology of atomizing liquid for conventional spray coating processes may be broadly classified into methods using pressure energy, gas energy, centrifugal energy, mechanical energy, and electrical energy.

Herein, the method of using pressure energy is a method of using pressure injection valves, wherein the liquid to be atomized is passed through single hole or porous injection nozzles, or vortex injection valves(simplex, duplex, dual orifice, and reflux types etc.) to form spray. This is a method generally used to spray liquid fuel injected into a gas turbine burner, randomly creating droplets of approximately 20˜250 μm. Therefore, in such a method of using pressure energy, there is a problem that it is difficult to be applied to a complicated coating technology.

In addition, the method that uses centrifugal energy utilizing a wheel atomizer or rotary cup atomizer is a method of randomly creating droplets of a range of 10˜200 μm. It is a method mainly used in cleaning and agriculture areas. In this method, it is impossible to coat the central portion, and thus there is a problem that it is difficult to be applied to a uniform coating technology.

Meanwhile, there is a gas bombardment atomizer method which is method of using gas energy, wherein a great quantity of gas in a low speed and low pressure state is injected towards a jet of liquid that is being injected using a two-fluid injection valve to atomize the liquid, and a gas assisted atomizer method wherein a small amount of gas in a high speed state is injected towards a liquid jet. This method is mainly used in thin film wet coating, but in this method, the droplets would be formed to have a random size between 15˜200 μm, thus making it difficult to form a fine thin film coating, and stains may occur on the coating surface, and further, due to the high fluid speed when injecting the gas at a high speed, the fast fluid speed may make the atomized droplets collide with the substrate, causing the droplets to bounce back. In addition, there may be too much coating liquid coming off the substrate, causing a waste of the coating liquid, thereby increasing manufacturing costs, and since the viscosity of the liquid that can be used is limited to less than 50 cp, there may be limitations in the coating technology in developing or applying functional materials, causing difficulty in developing various types of coating technologies.

Furthermore, the most representative method of using mechanical energy is the ultrasound spray technology wherein liquid is atomized by high frequency signals applied by a piezoelectric actuator. In this method, droplets may be further atomized than when using gas energy, but droplets are formed to have a random size between 1˜200 μm, making it difficult to secure uniformity in the size of droplets, and there is also a limitation in the amount of injection of droplets, thereby causing a problem of difficulty in utilizing in mass production processes.

Meanwhile, as a method of using electrical energy, there is the electrospray method wherein droplets are drawn towards a strong electric field and then atomized. An advantage of this method is that it is possible to produce fine and uniform droplets having a size range of hundreds nm to 5 μm. However, there are limitations that there needs to be at least 10⁻⁴ S/m of electrical conductivity, and that the amount of liquid sprayed is limited to 10⁻¹⁰ to 10⁻¹⁹ m³/sec, thereby making it difficult to be applied to mass product processes.

### SUMMARY

Therefore, the purpose of the present disclosure is to resolve the aforementioned problems of prior art, that is, to provide a spray nozzle that is capable of stably injecting fine droplets having a uniform size, whereby it is possible to increase the amount of injection so that it may be applied to mass production processes, and a coating system thereof.

Furthermore, another purpose of the present disclosure is to provide a spray nozzle that is capable of spraying liquid regardless of the electrical conductivity of the liquid, and that is not greatly limited by the viscosity of the liquid, and a coating system thereof.

In a general aspect, there is provided a spray nozzle comprising: a liquid nozzle injecting liquid towards a substrate; a gas nozzle for injecting gas, and for making the gas collide with the liquid on an injection path of the liquid to perform a primary atomization of the liquid; and a voltage supply connected to the liquid nozzle, the voltage supply for applying voltage to the liquid nozzle to generate an electric field between the liquid nozzle and substrate to perform a secondary atomization of the liquid.

In the general aspect of the spray nozzle, it is desirable that the spray nozzle further comprises a case for accommodating the liquid nozzle inside thereof, and that the liquid and gas are made to collide with each other outside the case.

In the general aspect of the spray nozzle, it is desirable that the spray nozzle further comprises a case for accommodating the liquid nozzle and gas nozzle inside thereof, the case provided with a gas path for guiding a flowing direction of the gas so that the gas being injected from the gas nozzle collides with the liquid on the injection path of the liquid, and that the gas is made to collide with the liquid inside the case.

In the general aspect of the spray nozzle, it is desirable that the case is provided with a guide part that is dented towards the inside on an end closer to the substrate, a cross-sectional area of the guide part increasing as it gets farther from the substrate, in order to guide an injection direction of the liquid so that the liquid is injected towards the substrate.

In the general aspect of the spray nozzle, it is desirable that a distance between the guide part and the substrate is 1 cm or more so that a secondary atomization of the liquid can be completed between the guide part and the substrate.

In the general aspect of the spray nozzle, it is desirable that the flow rate of the liquid supplied to the liquid nozzle is 10⁻⁸ m³/s or more.

In the general aspect of the spray nozzle, it is desirable that the liquid nozzle consists of a plurality of liquid nozzles each having a different diameter, any one of the plurality of liquid nozzles accommodating another of the plurality of liquid nozzles inside thereof or any one of the plurality of liquid nozzles accommodated inside of another of the plurality of liquid nozzles.

In the general aspect of the spray nozzle, it is desirable that the gas path guides the flowing direction of the gas so that the gas vertically collides with the injection path of the liquid.

In another general aspect, there is provided a coating system using a spray nozzle, the coating system comprising a substrate part where a substrate is disposed; a spray nozzle injecting liquid towards a surface of the substrate according to any one of claims 1 to 9; an amperometer connecting the spray nozzle and the substrate, and measuring current information between the spray nozzle and the substrate; a liquid supply supplying liquid being injected from the liquid nozzle; a gas supply supplying gas flowing inside the gas path; and a controller receiving the current information between the substrate and the spray nozzle from the amperometer and controlling injection conditions of the liquid being injected towards the substrate or a movement of the spray nozzle, with at least one of a voltage amount applied to the liquid nozzle and a pressure of the gas being supplied to the gas path predetermined.

In the general aspect of the coating system, it is desirable that the controller comprises an electric field control module controlling an electric field formed between the spray nozzle and the substrate by adjusting a voltage amount being applied to the liquid nozzle through the voltage supply.

In the general aspect of the coating system, it is desirable that the controller comprises a pressure control module controlling a pressure of the gas being supplied to the gas path from the gas supply.

In the general aspect of the coating system, it is desirable that the controller further comprises a current amount control module receiving current information obtained by the amperometer and controls a current amount between the substrate and the spray nozzle.

In the general aspect of the coating system, it is desirable that the coating system further comprises a nozzle transferrer connected to the spray nozzle, the nozzle transferrer moving the spray nozzle in a direction away from or approaching the substrate or along a virtual plane that is parallel to the substrate.

In the general aspect of the coating system, it is desirable that the controller comprises a transfer control module controlling a movement of the spray nozzle by adjusting a movement of the nozzle transferrer.

In the general aspect of the coating system, it is desirable that the controller comprises an injection speed control module controlling an injection speed of the liquid being injected from the spray nozzle by adjusting a flow rate of the liquid being supplied from the liquid supply.

In the general aspect of the coating system, it is desirable that the coating system further comprises a test substrate to which liquid being injected from the spray nozzle is shot, the test substrate testing a injection state of the spray nozzle through current information of the liquid shot, and that the amperometer is connected between the liquid nozzle and the test substrate and measures the current information of the shot liquid.

According to the present disclosure, there is provided a spray nozzle that may atomize liquid being injected in a uniform size, and a coating system thereof.

In addition, it is possible to increase the sprayed capacity so as to be applied to mass production processes.

In addition, it is possible to atomize and inject liquid regardless of whether the material has a low electrical conductivity or it is a non-polar material.

In addition, it is possible to guide the liquid being injected towards the substrate, thereby improving the amount of material consumption.

In addition, it is possible to stably inject liquid regardless of whether or not the material has a viscosity of 100 cp or more.

### BRIEF DESCRIPTION OF THE DRAWINGS

Throughout the drawings and the detailed description, unless otherwise described, the same drawing reference numerals will be understood to refer to the same elements, features, and structures. The relative size and depiction of these elements may be exaggerated for clarity, illustrating, and convenience.

FIG. 1 is a schematic cross-sectional view of a spray nozzle according to a first exemplary embodiment of the present disclosure.

FIG. 2 is a schematic cross-sectional view of a spray nozzle according to a second exemplary embodiment of the present disclosure.

FIG. 3 is a schematic plane view of a spray nozzle according to a second exemplary embodiment of the present disclosure.

FIG. 4 is a schematic cross-sectional view of a spray nozzle according to a third exemplary embodiment of the present disclosure.

FIG. 5 is a schematic cross-sectional view of a spray nozzle according to a fourth exemplary embodiment of the present disclosure.

FIG. 6 is a photograph showing different states of injection of liquid in different voltages from a spray nozzle according to FIGS. 1 to 5.

FIG. 7 is a photograph showing a PET film coated with PEDOT conducting polymer through a spray nozzle according to FIGS. 1 to 5.

FIG. 8 is a photograph showing surface roughness of a film coated according to FIG. 7.

FIG. 9 is a schematic view of a coating system using a spray nozzle according to a fifth exemplary embodiment of the present disclosure.

FIG. 10 is a schematic view of a controller in a coating system using a spray nozzle according to FIG. 9.

FIG. 11 is a schematic graph of a result of monitoring a stable initial spraying state through an amperometry in a coating system using a spray nozzle according to FIG. 9.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Hereinbelow is detailed explanation of a spray nozzle according to a first exemplary embodiment of the present disclosure and a coating system thereof with reference to the attached drawings.

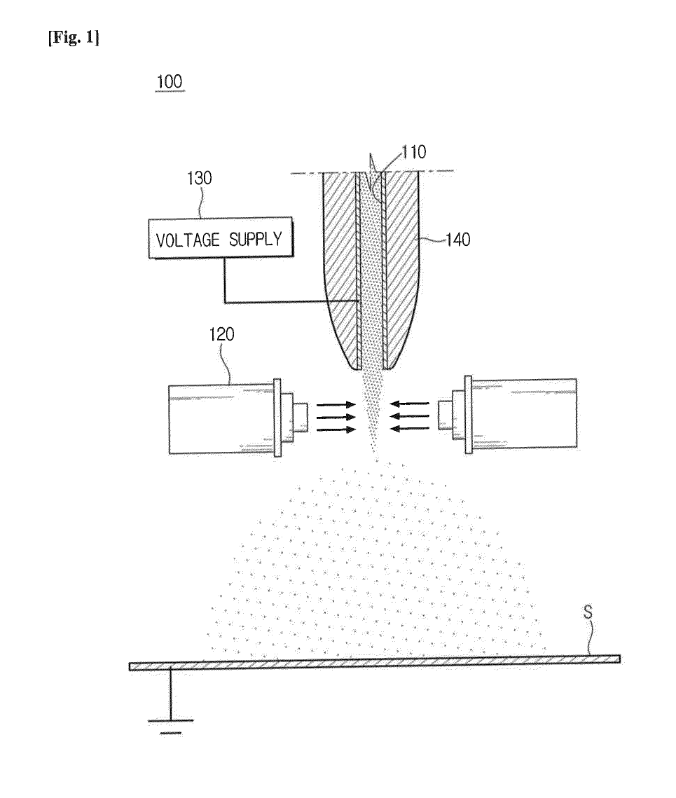

FIG. 1 is a schematic cross-sectional view of a spray nozzle according to a first exemplary embodiment of the present disclosure.

With reference to FIG. 1, a spray nozzle according to a first exemplary embodiment of the present disclosure 100 may make the liquid being injected to collide with gas, thereby performing a primary atomization of the liquid, and then apply an electric field to the atomized liquid, thereby performing a secondary atomization, so as to inject the liquid in a fine droplet state having a uniform size. This spray nozzle 100 comprises a liquid nozzle 110, gas nozzle 120, voltage supply 130, and case 140.

The liquid nozzle 110 is a path for liquid to flow, whereby liquid is injected towards a substrate.

The gas nozzle 120 is a path for gas, whereby gas is injected towards an injection path of liquid so that the gas collides with the liquid and thus a primary atomization of the liquid can be performed.

Herein, the gas nozzle 120 may preferably inject gas such that the gas vertically collides with the injection path of the liquid.

In other words, collision of the gas and liquid is a very important factor to the primary atomization of the liquid, and thus in order to atomize the liquid stably, the gas and the injection path of the liquid must collide vertically to each other.

That is, if the gas fails to vertically collide with the injection path of the liquid, the gas may have an effect in the injection direction of the liquid or in the opposite direction of the injection direction, and in the case where force is applied in the injection direction of the liquid by collision, atomized droplets would collide with the substrate S at a too fast speed, thereby possibly causing rebounding of the droplets, whereas in the case where force is applied in the opposite direction of the injection direction of the liquid by collision, the injection of the liquid would be interrupted by the gas, thereby possibly having a negative effect on the injection speed or injection flow rate.

Therefore, in order to prevent these problems, it is desirable that the gas vertically collides with the injection path of the liquid, but there is no limitation thereto, since it is also possible to resolve the aforementioned problems by adjusting the injection speed of the liquid.

Furthermore, the gas nozzle 120 may be provided such that gas is injected along a tangent direction of an outer circumference of the liquid injection path, but there is no limitation thereto.

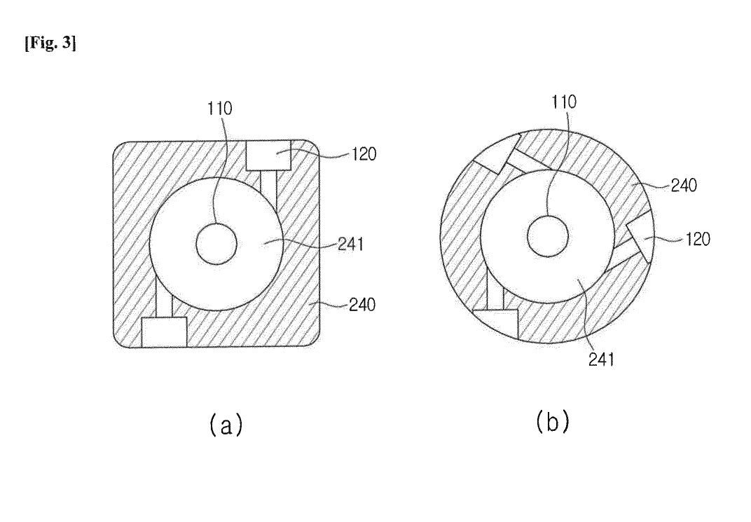

FIG. 3 is a schematic plane view of a spray nozzle according to a second exemplary embodiment of the present disclosure.

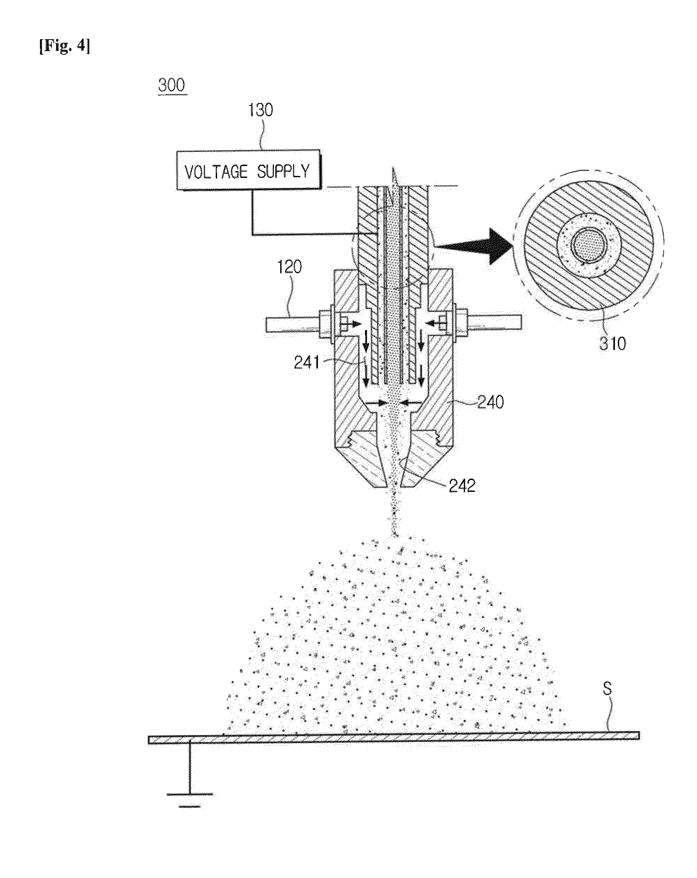

With reference to FIG. 3 or FIG. 4, there is a plurality of gas nozzles 120, each of which is spaced by a same distance from one other on an outer circumference of the liquid injection path, such that gas may be injected along a tangent direction of the outer circumference of the liquid injection path, but there is no limitation thereto.

The voltage supply 130 is electrically connected to the liquid nozzle 110, and generates an electric field between the liquid nozzle 110 and substrate S, more particularly between the spray nozzle 100 and substrate S so as to perform a primary atomization of the liquid by collision with the gas.

Herein, the substrate S is at a ground state, and thus when voltage is applied from the voltage supply 130 to the liquid nozzle 110, a voltage difference would occur between the substrate S and the liquid nozzle 110, thereby creating an electric field.

As the liquid that has gone through the primary atomization by collision with the gas is drawn by the electric field created by the voltage applied from the voltage supply 130, the liquid would go through a secondary atomization.

As such, by atomizing liquid sequentially by collision with gas and through an electric field, it is possible to create fine droplets of a uniform size and also inject a large amount of liquid. Furthermore, by guiding the liquid to be injected towards the substrate S using the electric field, it is possible to resolve the problem of the rebounding of the droplets, and reduce material consumption at the same time.

The case 140 is for accommodating the liquid nozzle 110 inside thereof.

That is, the gas nozzle 120 is provided outside the case 140, unlike the liquid nozzle 110, and thus the collision with the gas occurs outside the case 140.

Hereinbelow is explanation on operations of a first exemplary embodiment of the aforementioned spray nozzle.

First of all, liquid supplied from outside, more preferably liquid supplied from a separate liquid supply is supplied to the liquid nozzle 110, flows inside the liquid nozzle 110, and is then injected towards the substrate S.

The liquid injected towards the substrate S collides with the gas injected from the gas nozzle 120 between the substrate S and the case 140, and a primary atomization occurs by the collision with the gas. By the collision with the gas, the surface of the liquid becomes unstable, and due to this instability of the liquid surface, the secondary atomization by the electric field would occur actively even when the liquid has non-polarity or has an extremely low electrical conductivity, and more detailed explanation thereof will be mentioned hereinafter.

Herein, in order to prevent the collision with the gas affecting the injection speed of the liquid, it is preferable that the gas vertically collides with the injection path of the liquid, but there is no limitation thereto.

The liquid would go through a primary atomization by collision with the gas, and then this unstablized liquid surface goes through a secondary atomization by the electric field created between the nozzle 100 and the substrate S. Since the liquid has already been atomized by collision with the gas, the flow rate of the liquid that can be atomized increases significantly, which directly leads to the increase of process speed.

Meanwhile, liquid having non-polarity or having a low electrical conductivity may also be easily atomized by a spray nozzle according to a first exemplary embodiment of the present disclosure, and more detailed explanation thereon will be mentioned hereinbelow.

The force applied to an electric spraying that uses electric energy is as follows:

$${\vec{f}}_{e} = {ρ}_{e} \vec{E} - \frac{1}{2} \vert \vec{E} \vert {}^{2} {∇}_{ɛ} + ∇ ( \frac{1}{2} ( ɛ - {ɛ}_{0} ) {\vert \vec{E} \vert}^{2} )$$

Herein, ρₑ indicates free electron on liquid surface, ∈ indicates dielectric constant of the liquid surface, ∈₀ indicates dielectric constant in vacuum, and E indicates electric field.

Herein, in the case of dielectric liquid, in the above equation, the second and third forces will be applied, while in the case of a non-polar liquid, in the above equation, an electric force of the second section will be applied. This is called a dielectrophoretic force. Herein, since there exists only an electric force that acts on the vertical direction of the liquid surface and not in the direction tangent to the liquid surface, there won't be formed a liquid surface having a conical shape called the taylor-cone, and thus atomizing the liquid will not be easy with only an electric field.

However, by making droplets unstable at the same time of performing a primary atomization by inducing collision with gas as in a spray nozzle according to a first exemplary embodiment of the present disclosure 100, a secondary atomization may occur in spite of a weak dielectrophoretic force.

Accordingly, by utilizing a spray nozzle according to an exemplary embodiment of the present disclosure 100, it is possible to easily induce atomization of even nonconductive liquid regardless of the polarity of the liquid.

Next is explanation on a spray nozzle according to a second exemplary embodiment of the present disclosure 200.

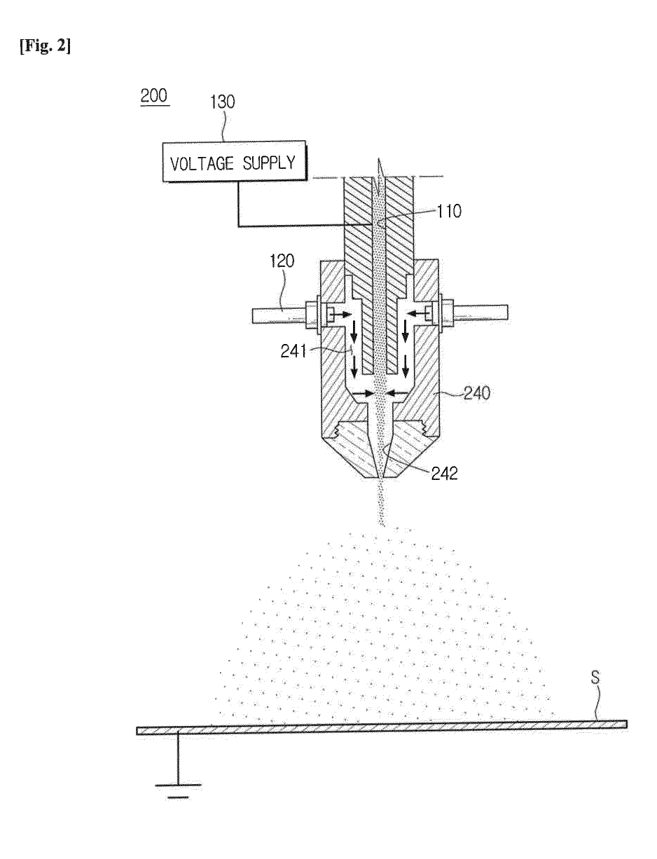

FIG. 2 is a schematic cross-sectional view of a spray nozzle according to a second exemplary embodiment of the present disclosure.

With reference to FIG. 2, a spray nozzle according to a second exemplary embodiment of the present disclosure 200 may make the liquid being injected to collide with gas, thereby performing a primary atomization of the liquid, and then applying an electric field to the atomized liquid, thereby performing a secondary atomization, so as to inject the liquid in a fine droplet state having a uniform size. This spray nozzle 200 comprises a liquid nozzle 110, gas nozzle 120, voltage supply 130, and case 140.

The functions of the liquid nozzle 110, gas nozzle 120 and voltage supply 130 are the same those according to the first exemplary embodiment of the present disclosure, and thus further explanation is omitted.

The case 240 is for accommodating the liquid nozzle 110 and the gas nozzle 120 inside, and making the liquid and gas collide inside thereof.

That is, the second exemplary embodiment is different from the first exemplary embodiment in that when liquid is injected outside the case 240, the liquid will be in a state that had already gone through a primary atomization, and then outside of the case 240, a secondary atomization will be performed by an electric field.

Meanwhile, inside the case 240, the gas injected from the gas nozzle 120 flows, and there is also formed a gas flow path 241 that guides gas to vertically collide with the injection path of the liquid.

The reason why the gas has to collide with the injection path of the liquid was explained hereinabove and thus repeated explanation is omitted.

In addition, the case 240 may be provided with a guide part 242 that guides liquid to be injected towards a substrate S, but there is no limitation thereto.

Herein, the guide part 242 is provided on a surface near the substrate S in the case 240, but the cross-section area of the guide part 242 increasing as it gets farther from the substrate S, but there is no limitation thereto.

Next is explanation on a spray nozzle according to a third exemplary embodiment of the present disclosure 300.

FIG. 3 is a schematic plane view of a spray nozzle according to a second exemplary embodiment of the present disclosure.

With reference to FIG. 3, a spray nozzle according to a third exemplary embodiment of the present disclosure 300 comprises a liquid nozzle 310, gas nozzle 120, voltage supply 130, and case 240.

The gas nozzle 120 and voltage supply 130 are the same as those in the first exemplary embodiment of the present disclosure, and the case 240 is the same as that in the second exemplary embodiment of the present disclosure, and thus detailed explanation is omitted.

The liquid nozzle 310 is where liquid flows inside and injects the liquid towards the substrate S. In the spray nozzle according to the third exemplary embodiment of the present disclosure 300, there is provided a plurality of liquid nozzles 310 having different diameters, one of the plurality of liquid nozzles accommodating another liquid nozzle or one of the plurality of liquid nozzles accommodated inside another liquid nozzle.

Herein, the plurality of liquid nozzles 110 may have a same central axis, the liquid nozzle 110 with the smallest diameter disposed sequentially starting from the middle and the liquid nozzle 110 with the largest diameter disposed outermost, but there is no limitation thereto.

In addition, the liquid flowing inside the plurality of liquid nozzles 310 may consist of numerous different liquids. Herein, numerous different liquids may be supplied to the different liquid nozzles 310, and then as they flow along the injection path of the liquid, and then collide with gas, they may be mixed together, and thus when they are injected outside the case 240, they may be injected as a mixed liquid, but there is no limitation thereto.

Next is explanation on a spray nozzle according to a fourth exemplary embodiment of the present disclosure 400.

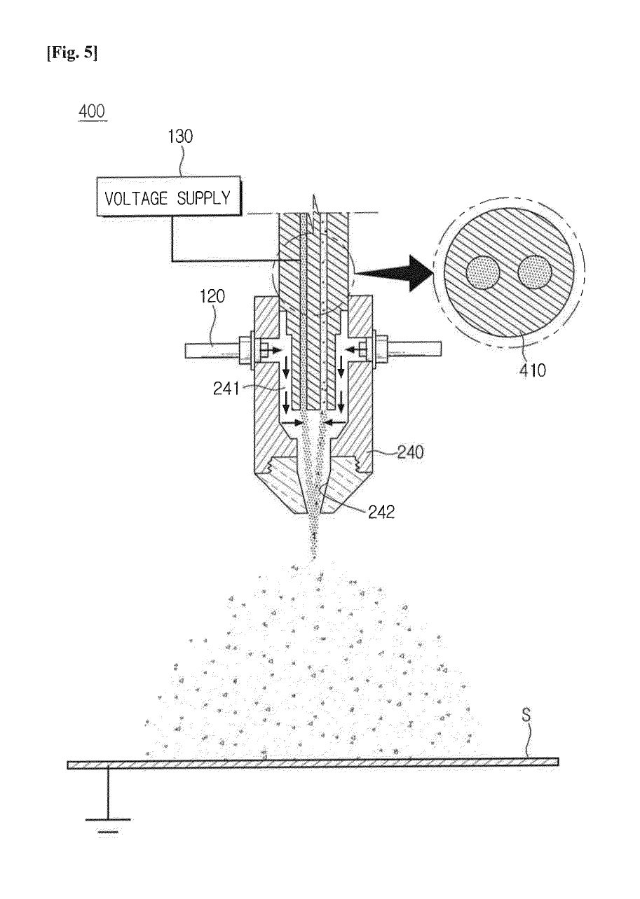

FIG. 5 is a schematic cross-sectional view of a spray nozzle according to a fourth exemplary embodiment of the present disclosure.

With reference to FIG. 5, a spray nozzle according to a fourth exemplary embodiment of the present disclosure 400 comprises a liquid nozzle 410, gas nozzle 120, voltage supply 130, and case 240.

The gas nozzle 120 and voltage supply 130 are the same as those in the first exemplary embodiment of the present disclosure, and the case 240 is the same as that in the second exemplary embodiment of the present disclosure, and thus further detailed explanation is omitted.

The liquid nozzle 410 is where liquid flows inside, and injects the liquid towards the substrate S. In the spray nozzle according to the fourth exemplary embodiment of the present disclosure 400, there is provided a plurality of liquid nozzles 410, one of the plurality of liquid nozzles distanced in a parallel direction from another liquid nozzle.

Herein, the liquid flowing inside the plurality of liquid nozzles 410 may consist of numerous different liquids, and it is desirable that the plurality of liquid nozzles 410 are disposed closely to one another such that the different liquids are sufficiently mixed inside the case 240 and then be injected.

Next is explanation on an experimental example of an atomization process of a liquid regarding a spray nozzle according to a first, second, third or fourth exemplary embodiment of the present disclosure.

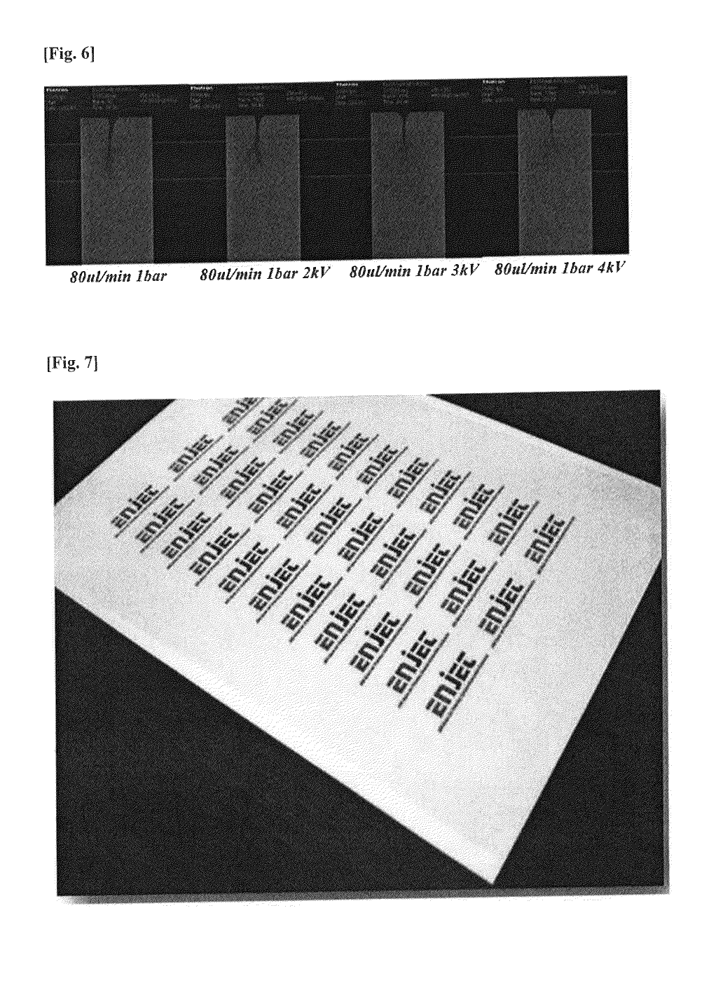

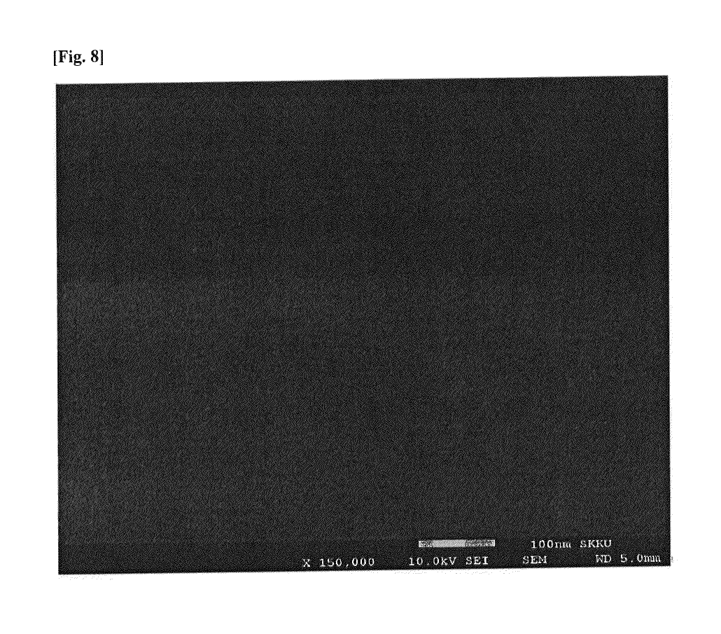

FIG. 6 is a photograph showing different states of injection of liquid in different voltages from a spray nozzle according to FIGS. 1 to 5, and FIG. 7 is a photograph showing a PET film coated with PEDOT conducting polymer through a spray nozzle according to FIGS. 1 to 5. And FIG. 8 is a photograph showing surface roughness of a film coated according to FIG. 7.

With reference to FIGS. 6 to 8, as the liquid, a high polymer conductive PEDOT that has a high viscosity and that is not easily atomized by the mutual connectivity of the high polymer material was used, supplied at a speed of 80 μl/min, and as gas, air was pressurized by 1 bar and used. Herein, the size of atomized liquid was in the range of approximately 10˜150 μm.

With reference to FIG. 6, a voltage was applied through the voltage supply 130, voltages of 2, 3, 4 kV were applied between the spray nozzle and substrate S, and there was a tendency that as the voltage increased the jet length of the liquid got shorter. Herein, the length of the liquid jet getting shorter means that the atomizing process of the liquid is active.

Meanwhile, in the case where the gas nozzle 120 has a diameter of 2.2 mm, the flow rate against the pressure applied is approximately 20˜120 cm³/sec, which is 1˜10 m/sec in velocity.

Herein, for the liquid that has gone through a primary atomization to go through a secondary atomization by an electric field, sufficient electric force should be obtained within the limited time it takes from the spray nozzle to the substrate S, and considering the speed within the applied pressure range, the time it takes for the droplets to approach the substrate is (distance between the substrate and spray nozzle)/speed, and according to the experiment, it took approximately 10 msec or more until the liquid completed the secondary atomization.

Therefore, the minimum distance needed from after a primary atomization is completed until a secondary atomization is completed is 1 cm, and as in one of the second exemplary embodiment to fourth exemplary embodiment of the present disclosure, in the case where liquid goes through a primary atomization inside the case 240 of the spray and goes through a secondary atomization outside the case 240, the distance between the spray nozzle and substrate S needed for the liquid to go through a secondary atomization sufficiently between the spray nozzle and the substrate S is 1 cm.

Meanwhile, according to the spray nozzle of the present disclosure, the flow rate of the liquid may be increased to 10⁻⁸ m³/sec or more, and according to the present experimental example, it can be seen that the flow rate of the liquid injected from the spray nozzle is 10⁻⁷ m³/sec, which is above the injection flow rate of approximately 10⁻¹⁰ to 10⁻⁹ m³/sec when using electric energy.

With reference to FIGS. 7 and 8, in the case of atomizing conductive PEDOT high polymer and injecting the same on a PET film according to the present experimental example, it was possible to obtain a highly transparent conductive film, upon observing the surface roughness using an electron microscope, the surface roughness appeared to be highly uniform.

Next is explanation on a coating system that uses a spray nozzle according to a fifth exemplary embodiment of the present disclosure.

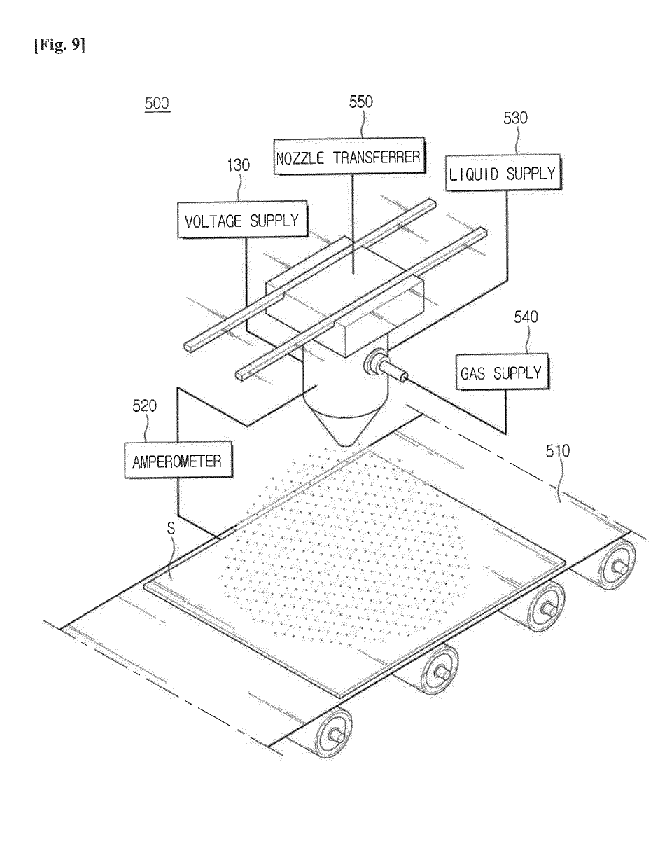

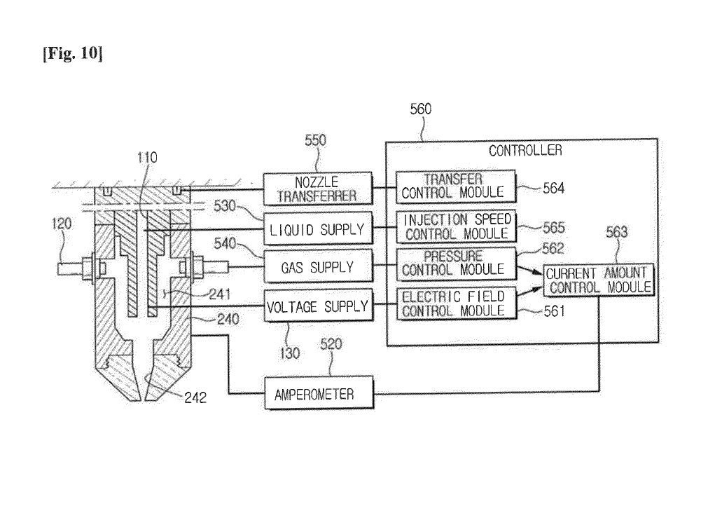

FIG. 9 is a schematic view of a coating system using a spray nozzle according to a fifth exemplary embodiment of the present disclosure, and FIG. 10 is a schematic view of a controller in a coating system using a spray nozzle according to FIG. 9.

With reference to FIGS. 9 and 10, a coating system that uses a spray nozzle according to a fifth exemplary embodiment of the present disclosure 500 performs coating using a spray nozzle according to first to fourth exemplary embodiments of the present disclosure. The coating system 500 also monitors whether or not the atomized liquid is being stably injected and coated on a substrate. The coating system 500 comprises a spray nozzle 100, 200, 300, 400 according to first to fourth exemplary embodiments, substrate part 510, amperometer 520, liquid supply 530, gas supply 540, nozzle transferrer 550, and controller 560.

The spray nozzle 100, 200, 300, 400 are the same as those in the aforementioned first to fourth exemplary embodiments, and thus detailed explanation thereof is omitted.

The substrate part 510 is on which a substrate S is disposed. In the coating system using a spray nozzle according to a fifth exemplary embodiment of the present disclosure, the substrate S is disposed on an upper part of the substrate part 510, and a transferrer is provided on a lower part of the substrate part 510, and then the coated substrate S is transferred to the next process, but there is no limitation thereto.

The amperometer 520 is electrically connected between the substrate S and the spray nozzle 100, 200, 300, 400. And the amperometer 520 measures the current between the substrate S and the spray nozzle 100, 200, 300, 400.

Herein, based on the current information between the substrate S and the spray nozzle 100, 200, 300, 400 obtained by the amperometer 520, it is possible to monitor whether or not liquid from the spray nozzle 100, 200, 300, 400 is being stably injected and atomized.

The liquid supply 530 supplies the liquid that flows inside the liquid nozzle 110 of the spray nozzle 100, 200, 300, 400, which is a well known technology and thus detailed explanation thereof is omitted.

The gas supply 540 supplies the gas that flows inside the gas nozzle 120 of the spray nozzle 100, 200, 300, 400, which is a well known technology and thus detailed explanation thereof is omitted.

The nozzle transferrer 550 is connected to the spray nozzle 100, 200, 300, 400 to transfer the spray nozzle 100, 200, 300, 400 in a direction away from or approaching the substrate S or along a virtual plane parallel to the substrate S.

That is, defining the direction of the spray nozzle 100, 200, 300, 400 away from or approaching the substrate S as being y axis, the nozzle transferrer 550 either transfers the spray nozzle 100, 200, 300, 400 in one direction of x axis, y axis, and z axis, or in at least a combination of two of the x axis, y axis, and z axis.

With reference to FIG. 10, with at least one of the voltage amount supplied from the voltage supply 130 and the pressure of the gas supplied from the gas nozzle 120 predetermined, the controller 560 receives the current information between the substrate S and the spray nozzle 100, 200, 300, 400 from the amperometer 520 and controls the injection conditions of the liquid being injected towards the substrate S or the movement of the spray nozzle 100, 200, 300, 400. The controller 560 comprises an electric field control module 561, pressure control module 562, current amount control module 563, transfer control module 564, and injection speed control module 565.

The electric field control module 561 adjusts the voltage applied to the liquid nozzle 110 through the voltage supply 130 and controls the electric field that occurs between the substrate S and the spray nozzle 100, 200, 300, 400.

As aforementioned, the size of the electric field relates to a secondary atomization of the liquid, and thus it is possible to control the speed of the second atomization by adjusting the size of the electric field by the electric field control module 561.

The pressure control module 562 adjusts the pressure of the gas that is supplied from the gas supply 540. As aforementioned, the primary atomization of the liquid occurs as the gas collides with the liquid being injected, and thus it is possible to control the primary atomization by adjusting the pressure of the gas flowing inside the gas nozzle 120.

The current amount control module 563 receives the current information obtained by the amperometer 520 and controls the current amount between the substrate S and spray nozzle 100, 200, 300, 400. The current amount control module 563 acknowledges the flow tendency of the current amount between the substrate S and spray nozzle 100, 200, 300, 400 and monitors whether or not the liquid is being injected and atomized stably.

That is, if there is almost no flow of current amount between the substrate S and spray nozzle 100, 200, 300, 400, it means that the liquid is being injected and atomized stably.

In addition, if there is flow of current amount, it means that the liquid is not being injected or atomized stably, and thus it is possible to control at least one of the electric field control module 561 and pressure control module 562 to redetermine the initial injection conditions of the liquid such as the size of the electric field and pressure of the gas so that the liquid can be injected and atomized stably, but there is no limitation thereto.

The transfer control module 564 controls the movement of the nozzle transferrer 550 to control the location and transferring speed of the spray nozzle 100, 200, 300, 400.

That is, it is possible to move the nozzle transferrer 550 to change the initial injection position of the spray nozzle 100, 200, 300, 400 or receive the current information obtained through the amperometer 520 and change the location of the spray nozzle 100, 200, 300, 400 to a location where the liquid can be injected stably, but there is no limitation thereto.

In addition, it is possible to transfer the spray nozzle 100, 200, 300, 400 even when the liquid is being injected, and control the transferring speed so that the liquid being injected is not affected by the transfer, but there is no limitation thereto.

The injection speed control module 565 controls the injection speed of the liquid being injected from the spray nozzle 100, 200, 300, 400 by adjusting the flow rate of the liquid supplied to the liquid nozzle 110.

When there is no change of the liquid density and diameter of the liquid nozzle 110, the injection speed of the liquid is proportional to the mass flow rate or volumetric flow rate of the liquid, and thus it is possible to control the injection speed of the liquid by adjusting the mass flow rate or volumetric flow rate of the liquid.

Herein, the injection speed of the liquid affects the time it takes for the liquid to arrive at the substrate S, and if this time is significantly short, the liquid may arrive at the substrate S without having gone through a secondary atomization sufficiently, resulting in increased and nonuniform surface roughness of the coating surface of the substrate S. Thus, the injection speed control module 565 controls the injection speed of the liquid.

Meanwhile, it is necessary to perform a coating operation after checking whether or not liquid is being injected stably from the spray nozzle 100, 200, 300, 400, and for this purpose an additional test substrate may be provided to examine the injection state of the spray nozzle 100, 200, 300, 400, but there is no limitation thereto.

Herein, an amperometer 520 may be additionally provided between the spray nozzle 100, 200, 300, 400 and the test substrate to measure the current amount between the spray nozzle 100, 200, 300, 400 and the test substrate, but there is no limitation thereto, and the amperometer 520 provided between the spray nozzle 100, 200, 300, 400 and the substrate S may be used instead.

Meanwhile, there may be further provided a cleaner for cleaning the spray nozzle 100, 200, 300, 400 but there is no limitation thereto.

Next is explanation on operations of a coating system using a spray nozzle according to a fifth exemplary embodiment of the present disclosure based on an experimental example.

In order to perform a coating operation with a coating system using a spray nozzle according to a fifth exemplary embodiment of the present disclosure, initial injection conditions are determined through the aforementioned electric field control module 561 and pressure control module 562.

In a coating system using a spray nozzle according to a fifth exemplary embodiment of the present disclosure, the voltage supplied from the voltage supply 130 is determined to 1, 2, 3, 4 kV through the electric field control module 561, and the pressure of the gas supplied from the gas supply 540 is determined to 1, 2, 3 bar through the pressure control module 562.

The current amount between the substrate S and spray nozzle 100, 200, 300, 400 is measured through the amperometer 520 by adjusting at least one of the voltage and pressure.

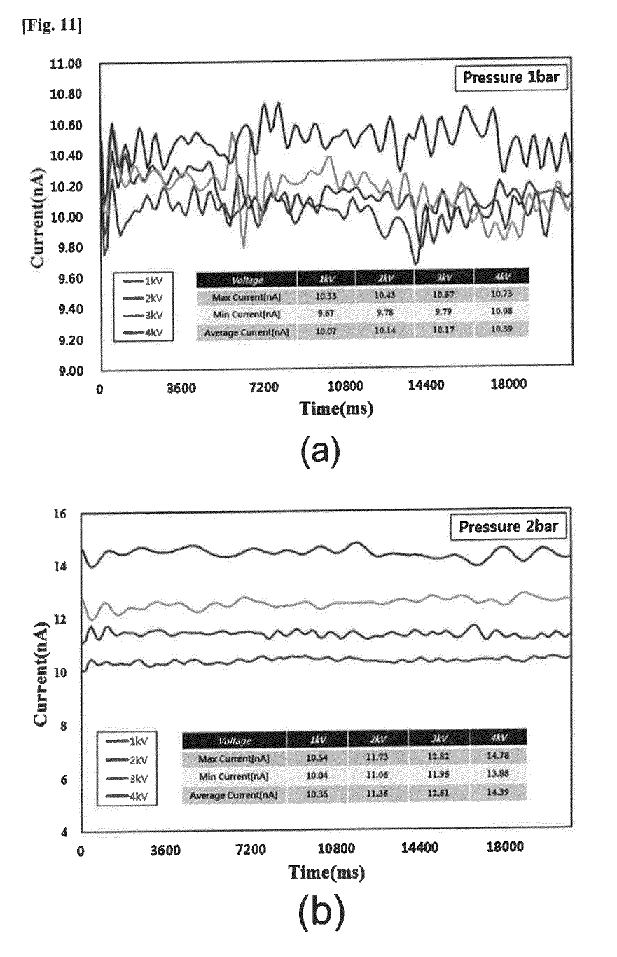

FIG. 11 is a schematic graph of a result of monitoring a stable initial spraying state through an amperometry in a coating system using a spray nozzle according to FIG. 9.

In FIG. 10, it is shown that when the pressure is 2 bar, the flow of the current amount does not change significantly even by change of voltage. Of course, this experimental example is a result derived in the case of using a coating system using a spray nozzle according to a fifth exemplary embodiment of the present disclosure 500, and thus if the size of the spray nozzle 100, 200, 300, 400 and the distance between the spray nozzle 100, 200, 300, 400 and the substrate are changed, the initial injection conditions would be different from the present experimental example, and thus there is no limitation thereto.

A number of examples have been described above. Nevertheless, it will be understood that various modifications may be made. For example, suitable results may be achieved if the described techniques are performed in a different order and/or if components in a described system, architecture, device, or circuit are combined in a different matter and/or replaced or supplemented by other components or their equivalents. Accordingly, other implementations are within the scope of the following claims.

### DESCRIPTION OF REFERENCE NUMERALS

100: SPRAY NOZZLE
110: LIQUID NOZZLE
120: GAS NOZZLE
130: VOLTAGE SUPPLY
140: CASE
S: SUBSTRATE
200: SPRAY NOZZLE
240: CASE
300: SPRAY NOZZLE
310: LIQUID NOZZLE
400: SPRAY NOZZLE
410: SPRAY NOZZLE
500: COATING SYSTEM USING SPRAY NOZZLE
510: SUBSTRATE PART
520: AMPEROMETER
530: LIQUID SUPPLY
540: GAS SUPPLY
550: NOZZLE TRANSFERRER
560: CONTROLLER

1. A spray nozzle comprising:
a liquid nozzle injecting liquid towards a substrate;
a gas nozzle for injecting gas to collide with the liquid on an injection path of the liquid to perform a primary atomization of the liquid; and
a voltage supply connected to the liquid nozzle, the voltage supply for applying voltage to the liquid nozzle to generate an electric field between the liquid nozzle and substrate to perform a secondary atomization of the liquid.

2. The spray nozzle according to claim 1, further comprising a case for accommodating the liquid nozzle inside thereof, wherein the liquid and gas are made to collide with each other outside the case.

3. The spray nozzle according to claim 1, further comprising a case for accommodating the liquid nozzle and gas nozzle inside thereof, the case provided with a gas path for guiding a flowing direction of the gas so that the gas being injected from the gas nozzle collides with the liquid on the injection path of the liquid, wherein the gas is made to collide with the liquid inside the case.

4. The spray nozzle according to claim 3, wherein the case is provided with a guide part that is dented towards the inside on an end closer to the substrate, a cross-sectional area of the guide part increasing as it gets farther from the substrate, in order to guide an injection direction of the liquid so that the liquid is injected towards the substrate.

5. The spray nozzle according to claim 4, wherein a distance between the guide part and the substrate is 1 cm or more so that a secondary atomization of the liquid can be completed between the guide part and the substrate.

6. The spray nozzle according to claim 3, wherein the gas path guides the flowing direction of the gas so that the gas vertically collides with the injection path of the liquid.

7. The spray nozzle according to claim 1, wherein a flow rate of the liquid supplied to the liquid nozzle is 10⁻⁸ m³/s or more.

8. The spray nozzle according to claim 1, wherein the liquid nozzle consists of a plurality of liquid nozzles each having a different diameter, any one of the plurality of liquid nozzles accommodating another of the plurality of liquid nozzles inside thereof or any one of the plurality of liquid nozzles accommodated inside of another of the plurality of liquid nozzles.

9. The spray nozzle according to claim 1, wherein the liquid nozzle consists of a plurality of liquid nozzles, any one of the plurality of liquid nozzles being distanced from another of the plurality of liquid nozzles in a parallel direction.

10. A coating system using a spray nozzle, the coating system comprising:
a substrate part where a substrate is disposed;
a spray nozzle injecting liquid towards a surface of the substrate according to claim 1;
an amperometer connecting the spray nozzle and the substrate, and measuring current information between the spray nozzle and the substrate;
a liquid supply supplying liquid being injected from the liquid nozzle;
a gas supply supplying gas flowing inside the gas path; and
a controller receiving the current information between the substrate and the spray nozzle from the amperometer and controlling injection conditions of the liquid being injected towards the substrate or a movement of the spray nozzle, when at least one of a voltage amount applied to the liquid nozzle and a pressure of the gas being supplied to the gas path are predetermined.

11. The coating system according to claim 10, wherein the controller comprises an electric field control module controlling an electric field formed between the spray nozzle and the substrate by adjusting a voltage amount being applied to the liquid nozzle through the voltage supply.

12. The coating system according to claim 10, wherein the controller comprises a pressure control module controlling a pressure of the gas being supplied to the gas path from the gas supply.

13. The coating system according to claim 10, wherein the controller further comprises a current amount control module receiving current information obtained by the amperometer and controls a current amount between the substrate and the spray nozzle.

14. The coating system according to claim 10, further comprising a nozzle transferrer connected to the spray nozzle, the nozzle transferrer moving the spray nozzle in a direction away from or approaching the substrate or along a virtual plane that is parallel to the substrate.

15. The coating system according to claim 14, wherein the controller comprises a transfer control module controlling a movement of the spray nozzle by adjusting a movement of the nozzle transferrer.

16. The coating system according to claim 10, wherein the controller comprises an injection speed control module controlling an injection speed of the liquid being injected from the spray nozzle by adjusting a flow rate of the liquid being supplied from the liquid supply.

17. The coating system according to claim 10,
further comprising a test substrate to which liquid being injected from the spray nozzle is shot, the test substrate testing a injection state of the spray nozzle through current information of the liquid shot, wherein the amperometer is connected between the liquid nozzle and the test substrate and measures the current information of the shot liquid.
